(19) United States
(12) Patent Application Publication
(10) Pub. No.: US 2023/0316295 A1
(43) Pub. Date: Oct. 5, 2023

(54) WARRANTY SYSTEM AND METHOD

(71) Applicant: Shimadzu Corporation, Kyoto-shi (JP)

(72) Inventors: Yozo FUKUDA, Kyoto-shi (JP); Masayuki HARAI, Kyoto-shi (JP); Akira HORIKOSHI, Kyoto-shi (JP); Kunimasa ITO, Kyoto shi (JP)

(21) Appl. No.: 18/127,565

(22) Filed: Mar. 28, 2023

(30) Foreign Application Priority Data
Mar. 30, 2022 (JP) 2022-055110

(51) Int. Cl. G06Q 30/012; G06Q 30/04

(52) U.S. Cl. CPC G06Q 30/012; G06Q 30/04

(57) ABSTRACT

An increase in a payment burden of a warranty provider to a supplier due to unpredictable parts failure is prevented while maintaining a normal commercial flow. A warranty provider computer is provided with a first notification unit, a second notification unit, and a third notification unit. The supplier computer is provided with a management unit for managing an amount of a pooled fund to be appropriated for the payment of a billing amount of an invoice and configured to add an amount of money corresponding to a first payment to the amount of the pooled fund when the occurrence of the first payment is notified, add the amount of money corresponding to the second payment to the amount of the pooled fund when the occurrence of the second payment is notified, and subtract a billing amount of the invoice from the amount of the pooled fund when the issuance of the invoice is notified.

### CROSS-REFERENCE TO RELATED APPLICATIONS

This application claims priority under 35 U.S.C. § 119 to Japanese Patent Application No. 2022-055110 filed on Mar. 30, 2022, the entire disclosure of which is incorporated herein by reference in its entirety.

### BACKGROUND OF THE INVENTION

### Field of the Invention

The present disclosure relates to a warranty system and a method thereof to be utilized between a warranty provider making a warranty contract with a plurality of users and a supplier supplying warranty parts related to the warranty contract.

### Description of the Related Art

The following description sets forth the inventor's knowledge of related art and problems therein and should not be construed as an admission of knowledge in the prior art.

Conventionally, a user using a product makes a warranty contract related to the product with a warranty provider.

Japanese Unexamined Patent Application Publication No. 2004-094371 describes a system related to a maintenance contract on equipment, such as, e.g., mainly a hardware product. In the system described in Japanese Unexamined Patent Application Publication No. 2004-094371, an access from a customer is accepted by a failure acceptance unit, and a maintenance work is performed based on the accepted failure information.

### SUMMARY OF THE INVENTION

A warranty provider, who made a warranty contract for a product with a user, visits the site to inspect the product upon receipt of a failure report from the user. When the warranty provider has determined that a failure is caused by parts, the warranty provider orders the parts to a supplier and pays the supplier for the parts to arrange for the replacement. Here, there exists a normal commercial flow of parts orders and payments for the ordered parts between the warranty provider as a consumer of the parts and the supplier.

When the warranty provider has determined that it is necessary to replace the parts, the warranty provider must immediately place an order for the parts with the supplier in order to shorten the failure period. Prompting the payment for the ordered parts is also critical to the warranty provider to maintain a trusting relationship between the supplier and the warranty provider who are doing business on the premise of the commercial flow as mentioned above.

Incidentally, it is difficult to predict the time when the parts of the user product fail. For this reason, the warranty provider needs to always prepare for the expenses associated with the need for parts replacement. When the target parts are expensive or the warranty provider has been consecutively contacted by a plurality of users for parts failure, the amount of money that must be paid for the parts at one time due to the parts replacement will become enormous. Considering these circumstances, the daily concerns of a warranty provider about expenses for unpredictable parts failures are unacceptably large.

An object of the present disclosure is to prevent a payment burden of a warranty provider to the supplier due to unpredictable parts failure from being increased while maintaining a normal commercial flow of parts orders and payments for ordered parts exchanged between the warranty provider and the supplier.

A warranty system according to one aspect of the present disclosure relates to a warranty system to be utilized between a warranty provider and a supplier, the warranty provider making a warranty contract for a part of a product with a plurality of users, the supplier providing the warranty provider with a warranty part related to the warranty contract, the warranty system comprising:
a warranty provider computer belonging to the warranty provider; and
a supplier computer belonging to the supplier,
wherein the warranty provider computer and the supplier computer communicate with each other via a network,
wherein the warranty provider computer is provided with:
a first notification unit configured to notify the supplier computer of an occurrence of a first payment from the warranty provider to the supplier in response to a payment of a warranty contract fee from each of the plurality of users to the warranty provider;
a second notification unit configured to notify the supplier computer of an occurrence of a second payment from the warranty provider to the supplier in a case where the supplier supplies the warranty part to the warranty provider; and
a third notification unit configured to notify the supplier computer of issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with:
a management unit configured to manage an amount of a pooled fund to be appropriated for a payment of a billing amount of the invoice; and
a storage unit configured to store the amount of the pooled fund, and
wherein the management unit is configured to
add an amount of money corresponding to the first payment to the amount of the pooled fund when the occurrence of the first payment is notified,
add an amount of money corresponding to the second payment to the amount of the pooled fund when the occurrence of the second payment is notified, and
subtract the billing amount of the invoice from the amount of the pooled fund when the issuance of the invoice is notified.

A method according to another aspect of the present disclosure relates to a method to be utilized between a warranty provider computer and a supplier computer, the warranty provider computer belonging to a warranty provider making a warranty contract for a part of a product with a plurality of users, the supplier computer belonging to a supplier providing the warranty provider with a warranty part related to the warranty contract, the method comprising:
a step of notifying the supplier computer by the warranty provider computer of an occurrence of a first payment from the warranty provider to the supplier in response to a payment of a warranty contract fee from each of the plurality of users to the warranty provider;
a step of notifying the supplier computer by the warranty provider computer of an occurrence of a second payment from the warranty provider to the supplier in a case where the supplier supplies the warranty part to the warranty provider; and
a step of notifying the supplier computer by the warranty provider computer of issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with a storage unit configured to store the amount of a pooled fund to be appropriated for a payment of a billing amount of the invoice; and
wherein the method further comprises:
a step of adding an amount of money corresponding to the first payment to the amount of the pooled fund by the supplier computer when the occurrence of the first payment is notified;
a step of adding an amount of money corresponding to the second payment to the amount of the pooled fund by the supplier computer when the occurrence of the second payment is notified; and
a step of subtracting the billing amount of the invoice from the amount of the pooled fund by the supplier computer when the issuance of the invoice is notified.

A method according to still another aspect of the present disclosure relates to a method using a supplier computer belonging to a supplier, the method being capable of being utilized between a warranty provider and the supplier, the warranty provider making a warranty contract for a part of a product with a plurality of users, the supplier providing the warranty provider with a warranty part related to the warranty contract, the method comprising:
a step of notifying the supplier of an occurrence of a first payment from the warranty provider to the supplier in response to a payment of a warranty contract fee from each of the plurality of users to the warranty provider;
a step of notifying the supplier of an occurrence of a second payment from the warranty provider to the supplier in a case where the supplier supplies the warranty part to the warranty provider; and
a step of notifying the supplier issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with a storage unit configured to store an amount of a pooled fund to be appropriated for a payment of a billing amount of the invoice; and
wherein the method further comprises:
a step of adding an amount of money corresponding to the first payment to the amount of the pooled fund by the warranty supplier when the occurrence of the first payment is notified,
a step of adding an amount of money corresponding to the second payment to the amount of the pooled fund when the occurrence of the second payment is notified, and
a step of subtracting the billing amount of the invoice from the amount of the pooled fund by the supplier computer when the issuance of the invoice is notified.

The above-described objects and other objects, features, aspects, and advantages of the present disclosure will become apparent from the following detailed descriptions of the present disclosure that can be understood with reference to the attached drawings.

### BRIEF DESCRIPTION OF THE DRAWINGS

The preferred embodiments of the present invention are shown by way of example, and not limitation, in the accompanying figures.

FIG. 1 is a block diagram showing an entire configuration of a warranty system.

FIG. 2 is a timing chart showing a flow of processing exchanged between a supplier and a warranty provider with respect to a warranty contract.

FIG. 3 is a block diagram showing a functional configuration of a supplier computer and a warranty provider computer.

FIG. 4 is a flowchart showing contents of processing of a supplier computer and a warranty provider computer.

FIG. 5 is a timing chart showing flows of a modification of the processing exchanged between a supplier and a warranty provider with respect to a warranty contract.

FIG. 6 is a diagram (modification) showing one example of a screen displaying a variation history of a pooled fund.

### BRIEF DESCRIPTION OF THE PROFFERED EMBODIMENTS

In the following paragraphs, some preferred embodiments of the present disclosure will be described by way of example and not limitation. It should be understood based on this disclosure that various other modifications can be made by those skilled in the art based on these illustrated embodiments.

Hereinafter, some embodiments of the present disclosure will be described in detail with reference to the attached drawings. In the drawings, the same or corresponding component is assigned by the same reference symbol, and the description thereof will not be repeated.

### <Overall Configuration of Warranty System 1>

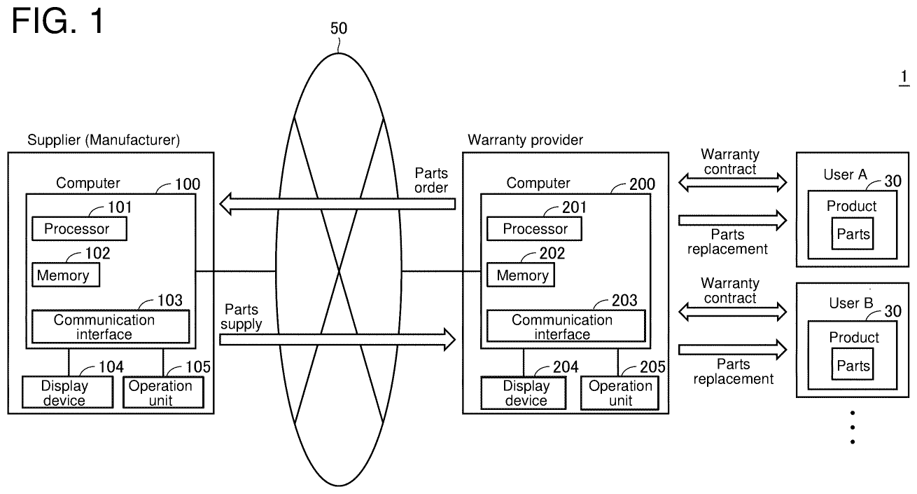

FIG. 1 is a block diagram showing an entire configuration of a warranty system 1. The warranty system 1 includes a supplier computer 100 operated by a supplier and a warranty provider computer 200 operated by a warranty provider. The supplier computer 100 and the warranty provider computer 200 are communicably connected via an network 50 represented by the Internet.

The supplier computer 100 and the warranty provider computer 200 are each configured by, for example, a personal computer. The supplier computer 100 is provided with a processor 101, a memory 102, and a communication interface 103. Like the supplier computer 100, the warranty provider computer 200 is provided with a processor 201, a memory 202, and a communication interface 203.

The processor 101 controls the operation of the entire supplier computer 100 by executing programs stored in the memory 102. Similarly, the processor 201 controls the operation of the entire warranty provider computer 200 by executing programs stored in the memory 202. The memories 102 and 202 each include a ROM (Read Only Memory), a RAM (Random Access Memory), a hard disk drive, and the like. The communication interfaces 103 and 203 each control the communication between the supplier computer 100 and the warranty provider computer 200 via the network 50.

Connected to the supplier computer 100 are a display device 104 and an operation unit 105, and connected to the warranty provider computer 200 are a display device 204 and an operation unit 205. The operation units 105 and 205 each are configured by a mouse, a keyboard, and the like. The supplier computer 100 may be configured to include the display device 104 and the operation unit 105, and the warranty provider computer 200 may be configured to include the display device 204 and the operation unit 205.

The supplier is a manufacturer that manufactures and sells an industrial product 30, such as, e.g., a spectrophotometer. The product 30 produced by the manufacturer is provided to users A, B, . . . The product 30 includes a plurality of parts replaceable depending on an occurrence of failure or aging events. For example, in a case where the product 30 is a spectrophotometer, a laser light source and various detectors correspond to the parts of the spectrophotometer.

The warranty provider makes a warranty contract with a user for the parts configuring the product 30. When a failure of warranty parts related to a warranty contract (hereinafter simply referred to as “parts”) has occurred, the warranty provider orders replacement parts to the supplier and receives the ordered parts from the supplier. The warranty provider replaces the defective parts with new parts free of charge. The warranty provider is composed of, for example, a service company providing such a warranty service.

### <Problems Between Warranty Provider and Supplier>

Between a warranty provider and a supplier, there exists a normal commercial flow in which the warranty provider orders the supplier for parts, and the supplier provides the warranty provider with the ordered parts on the premise that the warranty provider pays for the ordered parts. Given that business is established on the basis of such a commercial flow, it is vital for the warranty provider to maintain a trustworthy relationship with the supplier by promptly paying for the parts to the supplier.

Incidentally, it is difficult to predict the time when the user's product 30 fails. For this reason, the warranty provider is always required to prepare for expenses accompanied by necessity of parts replacement. In a case where the target parts are expensive, or the warranty provider has consecutively received failure contacts for the products 30 from a plurality of users, the amount of money that must be paid to the supplier at one time becomes enormous. Considering such circumstances, the daily concerns of the warranty provider about expenses for unpredictable parts failures are unacceptably large.

### <Summary of The Present Disclosure>

Therefore, in the present disclosure, a warranty system 1 is proposed in which a payment burden of the warranty provider to the supplier due to unpredictable parts failures can be prevented from increasing while maintaining the above-described normal commercial flow as a major premise. More specifically, in the present disclosure, a business model is proposed in which the supplier accumulates a part of warranty contract fees obtained by the warranty provider from users as a pooled fund, the warranty provider pays for the parts to the supplier, and then the loss of the warranty supplier by the payment of the parts costs is compensated by using the pooled fund. Furthermore, in the present disclosure, a warranty system 1 is provided in which the business model is supported from a technical aspect.

Hereinafter, the warranty system 1 will be described in detail. First, a flow of processing exchanged between a supplier and a warranty provider with respect to a warranty contract in the present disclosure will be described.

### <Processing Flow>

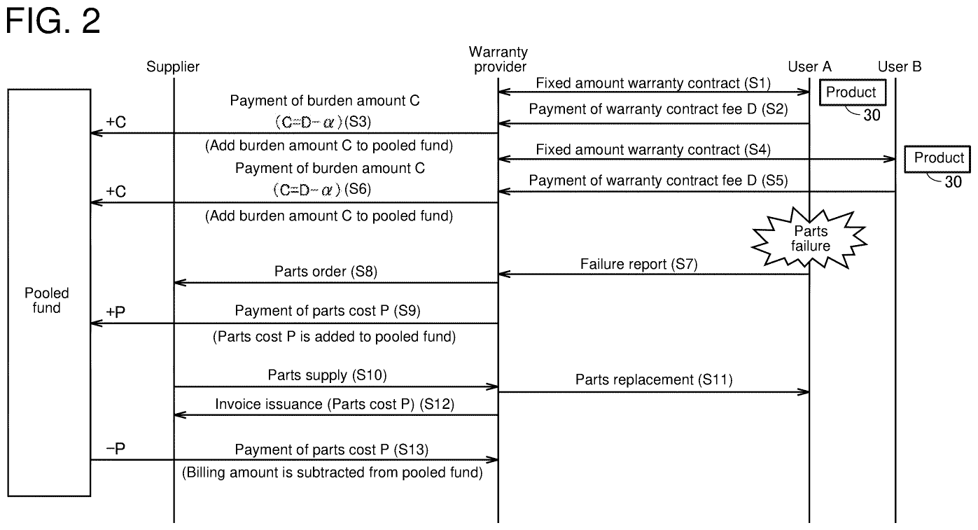

FIG. 2 is a timing chart showing a flow of processing exchanged between a supplier and a warranty provider with respect to a warranty contract. The warranty provider makes a warranty contract with a user A owning a product 30 at a fixed amount for the parts of the product 30 (Step S1). The number of the warranty target parts may be one or more. The warranty provider may change the warranty contract fee depending on the types and the number of contract target parts.

The user A pays the warranty contract fee D to the warranty provider (Step S2). The warranty provider may ask the user to pay the warranty contract fee in one lump sum for the contract period, or may ask the user to pay the warranty contract fee monthly.

The warranty provider pays a part of the warranty contract fee D received from the user A as a burden charge C (C=D−α) (Step S3). The difference a between the warranty contract fee D and the burden charge C corresponds to the sales proceed of the warranty provider. The burden charge C is accumulated as a pooled fund in preparation for an occurrence of parts replacement.

Similar processing is performed between the warranty provider, a user B, and the supplier (Step S4 to Step S6). In a case where warranty contracts are concluded between the warranty provider and many users, a large amount of burden charges is added to the pooled fund.

Here, it is assumed that parts failure has occurred in the product 30 of the user A. The user A notifies the warranty provider of an occurrence of failure (Step S7). The warranty provider goes to the user destination as needed to identify defective parts.

Thereafter, the warranty provider orders the parts to be replaced to the supplier (Step S8) and pays the parts cost P to the supplier (Step S9). The supplier supplies the ordered parts to the warranty provider (Step S10). In Step S8 to Step S10, there exists a normal commercial flow in which the supplier provides the warranty provider with parts, on the premise of a payment of the parts cost by the warranty provider. The parts cost P paid to the supplier is added to the pooled fund.

The warranty provider replaces the obtained parts with the failed parts of the user (Step S11). The warranty provider issues an invoice related to the parts price P of the parts supplied to the supplier in Step S10 (Step S12).

The supplier pays the parts cost P charged by the invoice to the warranty provider using the pooled fund (Step S13). As a consequence, the loss of the warranty provider due to the payment (Step S9) for the parts cost is offset.

According to the above-described flow of the processing between the supplier and the warranty provider, it is possible to prevent the payment burden of the warranty provider to the supplier from increasing due to the occurrence of unpredictable parts failure while maintaining the normal commercial flow (Step S8 to Step S10) in which the supplier provides the warranty provider with parts, on the premise of payment of the parts cost by the warranty provider. In order to realize the processing between the supplier and the warranty provider, it is essential to properly manage the pooled fund.

The supplier and the warranty provider are expected to utilize a financial institution to deposit to or withdraw from the pooled fund. In this case, the pooled fund itself is stored in an account of a financial system. In this disclosure, a warranty system 1 is proposed below in which the above-described business model can be technically realized by managing the amount of pooled fund that fluctuates with the burden charges and the parts cost payments by the supplier computer 100.

Here, although an example is shown in which parts are supplied to the warranty provider after completion of the payment for the parts (Step S9 and Step S10), in the present disclosure, it may be configured to adopt a flow in which parts cost is paid after supplying the parts to the warranty provider.

### <Functional Configuration of Supplier Computer 100 and Warranty Provider Computer 200>

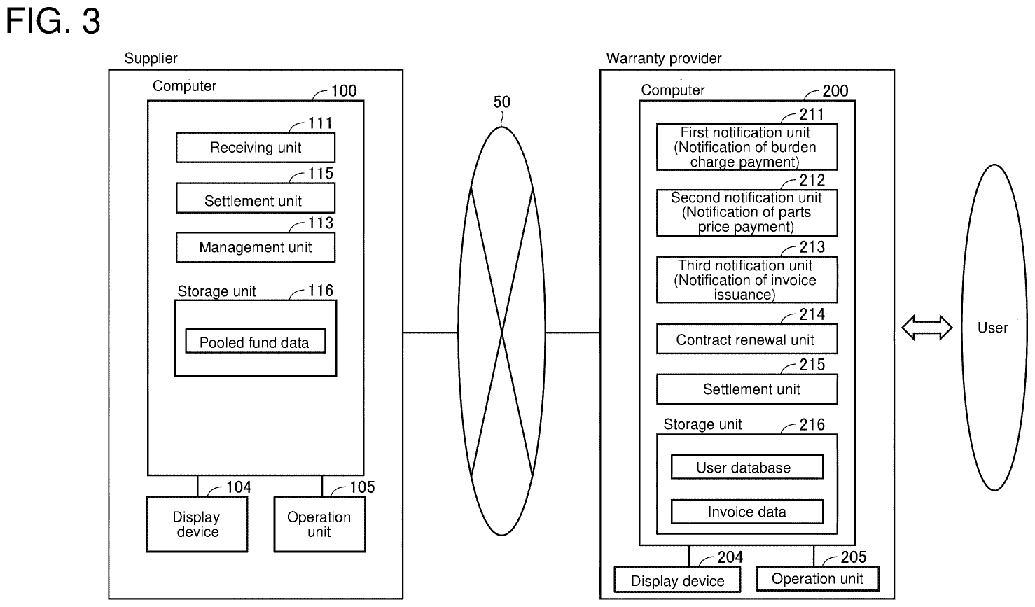

FIG. 3 is a block diagram showing a functional configuration of the supplier computer 100 and that of the warranty provider computer 200. The supplier computer 100 is provided with a receiving unit 111, a management unit 113, a settlement unit 115, and a storage unit 116. The warranty provider computer 200 is provided with a first notification unit 211, a second notification unit 212, a third notification unit 213, a contract renewal unit 214, a settlement unit 215, and a storage unit 216.

In the warranty provider computer 200, the storage unit 216 stores a user database and invoice data. The user database stores information on, e.g., the name and the address of the user, the product name, etc., that has concluded the warranty contract with the warranty provider. The invoice issued to the supplier when the warranty provider has received the parts from the supplier is stored in the storage unit 216 as invoice data.

In the warranty provider computer 200, the first notification unit 211 notifies the supplier computer 100 of an occurrence of payment of a burden charge when the payment of the burden charge has been made by the warranty provider (see Step S3, Step S6). The second notification unit 212 notifies the supplier computer 100 of the occurrence of the payment of the parts cost when the payment of the parts cost has been made by the warranty provider (see Step S9). The third notification unit 213 notifies the supplier computer 100 of issuance of an invoice when the invoice is issued by the warranty provider (see Step S12).

In the supplier computer 100, the storage unit 116 stores pooled fund amount data indicating the amount of the pooled fund. The management unit 113 manages the pooled fund mount data stored in the storage unit 116. The receiving unit 111 receives notifications from the first notification unit 211, the second notification unit 212, and the third notification unit 213. The management unit 113 adds the amount corresponding to the burden charge to the pooled fund amount data based on the notification from the first notification unit 211. The management unit 113 adds the amount corresponding to the parts cost to the pooled fund amount data based on the notification from the second notification unit 212. The management unit 113 subtracts the billing amount of the invoice from the pooled fund amount data based on the notification from the third notification unit 213.

The settlement unit 115 of the supplier computer 100 accesses the financial system of the financial institution in accordance with the supplier's manipulation of the operation unit 105 or automatically. Similarly, the settlement unit 215 of the warranty provider computer 200 accesses the financial system of the financial institution according to the supplier's manipulation of the operation unit 205 or automatically. The settlement units 115 and 215 each perform payment processing on the burden charge and the parts cost with respect to the pooled fund account of the supplier and the account of the warranty provider. The display device 104 displays the pooled amount, the notification contents of the first notification unit 211 to the third notification unit 213, and the like, according to the supplier's manipulation of the operation unit 105.

The contract renewal unit 214 updates the contents of the user database, for example, in a case where a warranty contract with a new user is made, and in a case where contents of an existing warranty contract are updated. The display device 204 displays the contents of the user database according to the manipulation of the operation unit 205 by the warranty provider.

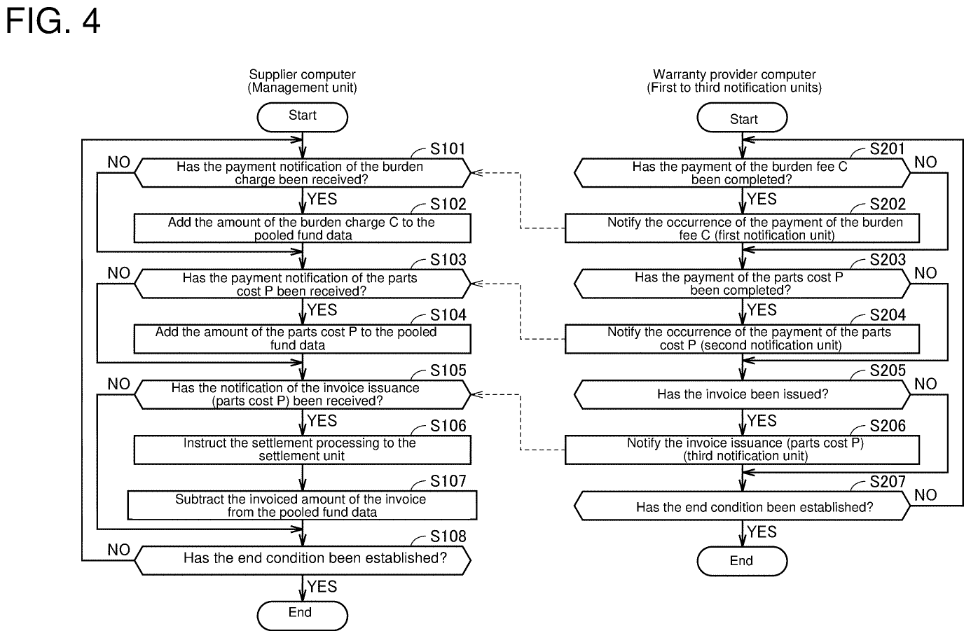

FIG. 4 is a flowchart showing the contents of the processing performed by the supplier computer 100 and the warranty provider computer 200. In particular, the contents of the processing of the management unit 113 of the supplier computer 100 and the contents of the processing of the first notification unit 211 to the third notification unit 213 of the warranty provider computer 200 will be described with reference to FIG. 4.

### <Processing of Warranty Provider Computer 200>

First, the processing of the warranty provider computer 200 will be described. The warranty provider computer 200 determines whether the payment of the burden charge C to the supplier has been completed (Step S201). For example, the warranty provider computer 200 determines, by the settlement unit 215, whether the payment of the burden charge C to the supplier has been completed. When the warranty provider computer 200 has determined that the payment of the burden charge C to the supplier has been completed, the warranty provider computer 200 notifies the supplier computer 100 of the occurrence of the payment of the burden charge C (Step S202).

The warranty provider computer 200 determines whether the payment for the parts cost P to the supplier has been completed (Step S203), after determining NO in Step S201 or after notifying the supplier computer 100 of the occurrence of the payment of the burden charge C. For example, the warranty provider computer 200 determines, by the settlement unit 215, whether the payment for the parts cost P to the supplier has been completed. When the warranty provider computer 200 has determined that the payment of the parts cost P to the supplier has been completed, the warranty provider computer 200 notifies the supplier computer 100 of the occurrence of the payment for the parts cost P (Step S204).

The warranty provider computer 200 determines whether an invoice has been issued, after determining NO in Step S203 or after notifying the supplier computer 100 of the occurrence of the payment for the parts cost P (Step S205). This determination corresponds to Step S12 of FIG. 2. The warranty provider issues an invoice for the parts price P of the parts to the supplier when the parts have been delivered from the supplier and inputs the data of the issued invoice to the warranty provider computer 200.

The input data is stored in the storage unit 216 as invoice data. The warranty provider computer 200 determines that an invoice has been issued in Step S205 when new invoice data is input and also identifies the billing amount. When the warranty provider computer 200 has determined that an invoice has been issued, the warranty provider computer 200 notifies the supplier computer 100 of the issuance of the invoice together with the billing amount (Step S206).

The warranty provider computer 200 determines whether the termination condition for terminating the processing is satisfied, after determining NO in Step S205 or after notifying the supplier computer 100 of the issuance of the invoice (Step S207). The termination condition is satisfied, for example, when a predetermined operation for terminating the processing of the warranty provider computer 200 is detected. When such an end condition is satisfied, the processing based on this flowchart ends. When the termination condition is not satisfied, the warranty provider computer 200 repeatedly executes the processing from Step S201.

### <Processing of Supplier Computer 100>

Next, the processing of the supplier computer 100 will be described. The supplier computer 100 determines whether a payment notification of the burden charge C has been received from the warranty provider computer 200 (Step S101). When the supplier computer 100 has determined that it has received the payment notification of the burden charge C from the warranty provider computer 200, the supplier computer 100 adds the amount of the burden charge C to the pooled fund amount data of the storage unit 116 (Step S102).

The supplier computer 100 determines whether the payment notification of the parts cost P has been received from the warranty provider computer 200, after determining NO in Step S101 or after adding the amount of the burden charge C to the pooled fund amount data of the storage unit 116 (Step S103). When the supplier computer 100 has determined that it has received the payment notification of the parts cost P from the warranty provider computer 200, the supplier computer 100 adds the amount of the parts cost P to the pooled fund amount data of the storage unit 116 (Step S104).

The supplier computer 100 determines whether a notification of an issuance of an invoice has been received from the warranty provider computer 200, after determining NO in Step S103 or after adding the amount of parts cost P to the pooled fund amount data of the storage unit 116 (Step S105). When the supplier computer 100 has determined that it has received the notification of the invoice issuance from the warranty provider computer 200, the supplier computer 100 instructs the settlement unit 115 to settle the billing amount of the invoice (Step S106) and then subtracts the billing amount of the invoice from the pooled fund amount data of the storage unit 116 (Step S107).

Note that when the supplier computer 100 has received the notification of the invoice issuance, the supplier computer 100 may display a message prompting the operator of the supplier to perform the payment processing of the amount of the invoice on the display device 104. In this case, the supplier computer 100 may execute processing of subtracting the billing amount of the invoice from the pooled fund amount data of the storage unit 116 in Step S107 when the settlement processing of the operator in response to the message has been confirmed.

The supplier computer 100 determines whether a termination condition for terminating the processing has been satisfied (Step S108), after determining NO in Step S105, or after subtracting the billing amount of the invoice from the pooled fund amount data of the storage unit 116. The termination condition is satisfied, for example, when the supplier computer 100 detects a predetermined operation for terminating the processing. When such an end condition is satisfied, the processing based on this flowchart ends. When the termination condition is not satisfied, the supplier computer 100 repeatedly executes the processing from Step S101.

By executing the processing of the supplier computer 100 and the warranty provider computer 200 described above, the supplier computer 100 can appropriately manage the amount of the pooled fund that varies according to the processing of Step S1 to Step S13 shown in FIG. 2. Consequently, the communication between the supplier, the warranty provider, and the user, as described using FIG. 2, can be appropriately realized. As a consequence, according to the present disclosure, it is possible to provide the warranty system 1 for supporting, from a technical aspect, a business model for preventing an increase in the payment burden of the warranty provider while maintaining the normal commercial flow as described using FIG. 2.

### Modifications

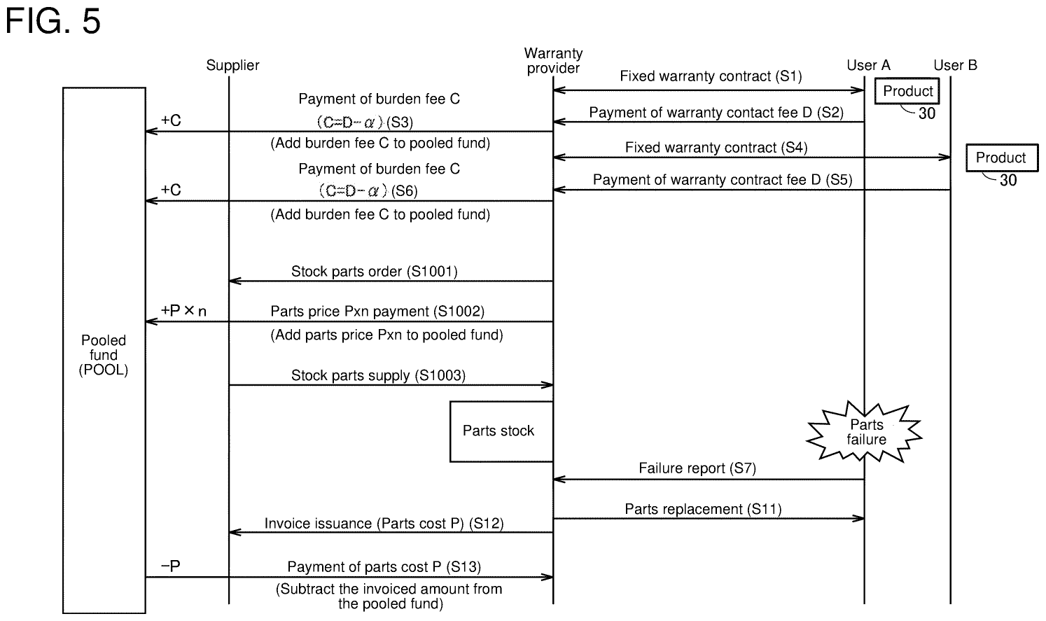

Next, modifications of the present disclosure will be described. FIG. 5 is a timing chart showing a flow of a modification of the processing exchanged between the supplier and the warranty provider with respect to a warranty contract. The above-described timing chart of FIG. 2 shows the flow of ordering replacement parts by the warranty provider to the supplier when parts failure has occurred. However, the warranty provider may reserve an inventory of replacement parts in advance. FIG. 5 shows a modification in a case where the warranty provider reserves an inventory of replacement parts.

The timing chart shown in FIG. 5 uses Step S1001 to Step S1003 instead of Step S8 to Step S10 in the timing chart shown in FIG. 2. Step S1001 to Step S1003 will be described.

The warranty provider orders a plurality of parts to be stocked (Step S1001) and pays the parts cost P×n corresponding to the number “n” of the parts ordered to the supplier (Step S1002). The parts cost P×n is added to the pooled fund. The supplier supplies the plurality of ordered parts to the warranty provider (Step S1003). The warranty provider reserves a plurality of supplied parts as stock and prepares for possible parts failure. The warranty system 1 according to the present disclosure is also intended to be applied to such a modification.

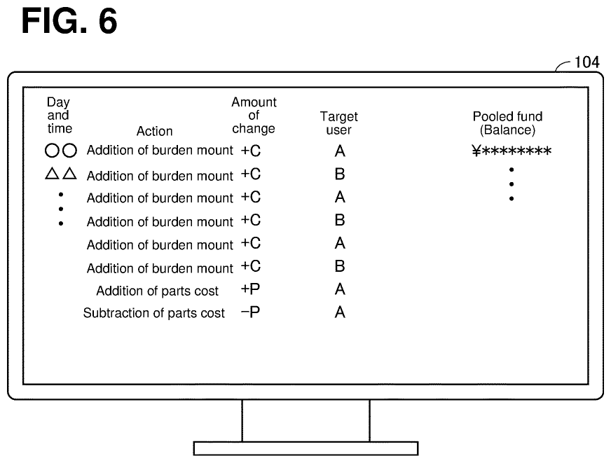

Next, another modification will be described with reference to FIG. 6. FIG. 6 shows one example of a screen showing a variation history of the pooled fund. For example, the supplier computer 100 may display a pooled fund variation history as shown in FIG. 6 on the display device 104. In the variation history shown in FIG. 6, the date and time when the action to change the pooled fund occurred, the contents of the action, the amount of changes (additional amount or subtraction amount) to change the pooled fund, the target user, and the remaining amount of the pooled fund after the change by the action are shown.

The warranty provider computer 200 adds the information on the users A and B to the information to be notified to the supplier computer 100 in Step S202, Step S204, and Step S206 of FIG. 4. With this, the supplier computer 100 can identify the user corresponding to the actions when each notification is received.

By displaying such a history on the display device 104, the supplier can confirm the variation status of the pooled fund by the content of the action and the user.

In the present disclosure, a spectrophotometer is exemplified as one example of the product 30 including warranty contract target parts. However, the product to which the present disclosure is applied is not limited thereto. For example, the warranty system 1 according to the present disclosure can also be applied to a warranty contract targeting parts of a product, such as, e.g., an X-ray CT examination device, a mass spectrometer, and a thermal analysis device.

In the present disclosure, an example is shown in which a supplier and a warranty provider have an one-to-one relationship. However, it is also assumed that one supplier and a plurality of warranty providers exchange the processing shown in FIG. 2. In such a case, the pooled funds may be shared by a plurality of warranty companies.

The supplier computer 100 may be located at a supplier location or at a remote location remote from the supplier location. Similarly, the warranty provider computer 200 may be located at a location of the warranty provider or at a remote location remote from the location of the warranty provider. For example, the supplier computer 100 may be configured by a server device provided in a cloud. In this case, a system in which an operator of the supplier accesses the server device may be constituted using a personal computer or the like installed at the location of the supplier.

### Aspects

It is understood by those skilled in the art that the above embodiment and modification thereof are specific examples of the following aspects.

### (Item 1)

A warranty system according to one aspect of the present disclosure related to a warranty system to be utilized between a warranty provider and a supplier, the warranty provider making a warranty contract for a part of a product with a plurality of users, the supplier providing the warranty provider with a warranty part related to the warranty contract, the warranty system comprising:
a warranty provider computer belonging to the warranty provider; and
a supplier computer belonging to the supplier,
wherein the warranty provider computer and the supplier computer communicate with each other via a network,
wherein the warranty provider computer is provided with:
a first notification unit configured to notify the supplier computer of an occurrence of a first payment from the warranty provider to the supplier in response to a payment of a warranty contract fee from each of the plurality of users to the warranty provider;
a second notification unit configured to notify the supplier computer of an occurrence of a second payment from the warranty provider to the supplier in a case where the supplier supplies the warranty part to the warranty provider; and
a third notification unit configured to notify the supplier computer of issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with:
a management unit configured to manage an amount of a pooled fund to be appropriated for a payment of a billing amount of the invoice; and
a storage unit configured to store the amount of the pooled fund, and
wherein the management unit is configured to
add an amount of money corresponding to the first payment to the amount of the pooled fund when the occurrence of the first payment is notified,
add an amount of money corresponding to the second payment to the amount of the pooled fund when the occurrence of the second payment is notified, and
subtract the billing amount of the invoice from the amount of the pooled fund when the issuance of the invoice is notified.

According to the warranty system as recited in the above-described Item 1, it is possible to prevent the payment burden of the warranty provider to the supplier from increasing due to unpredictable parts failure while maintaining a normal commercial flow of parts orders and payments for the ordered parts exchanged between the warranty provider and the supplier.

### (Item 2)

According to the warranty system as recited in the above-described Item 1, further comprising:
a display device,
wherein the supplier computer displays a history indicating a variation status of the amount of the pooled fund on the display device.

According to the warranty system described in Item 2, the supplier can check the variation status of the pooled fund. Note that the history showing the variation status of the amount of the pooled fund may include the occurrence history of actions for varying the pooled fund classified according to the first payment, the second payment, and the issuance of the invoice.

### (Item 3)

A method according to another aspect of the present disclosure related to a method to be utilized between a warranty provider computer and a supplier computer, the warranty provider computer belonging to a warranty provider making a warranty contract for a part of a product with a plurality of users, the supplier computer belonging to a supplier providing the warranty provider with a warranty part related to the warranty contract, the method comprising:
a step of notifying the supplier computer by the warranty provider computer of an occurrence of a first payment from the warranty provider to the supplier in response to a payment of a warranty contract fee from each of the plurality of users to the warranty provider;
a step of notifying the supplier computer by the warranty provider computer of an occurrence of a second payment from the warranty provider to the supplier in a case where the supplier supplies the warranty part to the warranty provider; and
a step of notifying the supplier computer by the warranty provider computer of issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with a storage unit configured to store the amount of a pooled fund to be appropriated for a payment of a billing amount of the invoice; and
wherein the method further comprises:
a step of adding an amount of money corresponding to the first payment to the amount of the pooled fund by the supplier computer when the occurrence of the first payment is notified;
a step of adding an amount of money corresponding to the second payment to the amount of the pooled fund by the supplier computer when the occurrence of the second payment is notified; and
a step of subtracting the billing amount of the invoice from the amount of the pooled fund by the supplier computer when the issuance of the invoice is notified.

According to the method as recited in the above-described Item 3, it is possible to prevent the payment burden of the warranty provider to the supplier from increasing due to unpredictable parts failure while maintaining a normal commercial flow of parts orders and a payment for the ordered parts exchanged between the warranty provider and the supplier.

### (Item 4)

A method according to still another aspect of the present disclosure relates to a method using a supplier computer belonging to a supplier, the method being capable of being utilized between a warranty provider and the supplier, the warranty provider making a warranty contract for a part of a product with a plurality of users, the supplier providing the warranty provider with a warranty part related to the warranty contract, the method comprising:
a step of notifying the supplier of an occurrence of a first payment from the warranty provider to the supplier in response to a payment of a warranty contract fee from each of the plurality of users to the warranty provider;
a step of notifying the supplier of an occurrence of a second payment from the warranty provider to the supplier in a case where the supplier supplies the warranty part to the warranty provider; and
a step of notifying the supplier issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with a storage unit configured to store an amount of a pooled fund to be appropriated for a payment of a billing amount of the invoice; and
wherein the method further comprises:
a step of adding an amount of money corresponding to the first payment to the amount of the pooled fund by the warranty supplier when the occurrence of the first payment is notified,
a step of adding an amount of money corresponding to the second payment to the amount of the pooled fund when the occurrence of the second payment is notified, and
a step of subtracting the billing amount of the invoice from the amount of the pooled fund by the supplier computer when the issuance of the invoice is notified.

According to the method as recited in the above-described Item 4, it is possible to prevent an increase in the payment burden of the warranty provider to the supplier due to unpredictable parts failure while maintaining a normal commercial flow of parts orders and payment for the ordered parts exchanged between the supplier and the warranty provider.

Although some embodiments of the present invention have been described, the embodiments disclosed herein are to be considered in all respects as illustrative and not restrictive. The scope of the present invention is indicated by claims, and it is intended to include all modifications within the meanings and ranges equivalent to those of the claims.

1. A warranty system to be utilized between a warranty provider and a supplier, the warranty provider making a warranty contract for a part of a product with a plurality of users, the supplier providing the warranty provider with a warranty part related to the warranty contract, the warranty system comprising:
a warranty provider computer belonging to the warranty provider; and
a supplier computer belonging to the supplier,
wherein the warranty provider computer and the supplier computer communicate with each other via a network,
wherein the warranty provider computer is provided with:
a first notification unit configured to notify the supplier computer of an occurrence of a first payment from the warranty provider to the supplier in response to a payment of a warranty contract fee from each of the plurality of users to the warranty provider;
a second notification unit configured to notify the supplier computer of an occurrence of a second payment from the warranty provider to the supplier in a case where the supplier supplies the warranty part to the warranty provider; and
a third notification unit configured to notify the supplier computer of issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with:
a management unit configured to manage an amount of a pooled fund to be appropriated for a payment of a billing amount of the invoice; and
a storage unit configured to store the amount of the pooled fund, and
wherein the management unit is configured to
add an amount of money corresponding to the first payment to the amount of the pooled fund when the occurrence of the first payment is notified,
add an amount of money corresponding to the second payment to the amount of the pooled fund when the occurrence of the second payment is notified, and
subtract the billing amount of the invoice from the amount of the pooled fund when the issuance of the invoice is notified.

2. The warranty system as recited in claim 1, further comprising:
a display device,
wherein the supplier computer displays a history indicating a variation status of the amount of the pooled fund on the display device.

3. A method to be utilized between a warranty provider computer and a supplier computer, the warranty provider computer belonging to a warranty provider making a warranty contract for a part of a product with a plurality of users, the supplier computer belonging to a supplier providing the warranty provider with a warranty part related to the warranty contract, the method comprising:
a step of notifying the supplier computer by the warranty provider computer of an occurrence of a first payment from the warranty provider to the supplier in response to a payment of a warranty contract fee from each of the plurality of users to the warranty provider;
a step of notifying the supplier computer by the warranty provider computer of an occurrence of a second payment from the warranty provider to the supplier in a case where the supplier supplies the warranty part to the warranty provider; and
a step of notifying the supplier computer by the warranty provider computer of issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with a storage unit configured to store the amount of a pooled fund to be appropriated for a payment of a billing amount of the invoice; and
wherein the method further comprises:
a step of adding an amount of money corresponding to the first payment to the amount of the pooled fund by the supplier computer when the occurrence of the first payment is notified;
a step of adding an amount of money corresponding to the second payment to the amount of the pooled fund by the supplier computer when the occurrence of the second payment is notified; and
a step of subtracting the billing amount of the invoice from the amount of the pooled fund by the supplier computer when the issuance of the invoice is notified.

4. A method using a supplier computer belonging to a supplier, the method being capable of being utilized between a warranty provider and the supplier, the warranty provider making a warranty contract for a part of a product with a plurality of users, the supplier providing the warranty provider with a warranty part related to the warranty contract, the method comprising:
a step of notifying the supplier of an occurrence of a first payment from the warranty provider to the supplier in response to a payment of a warranty contract fee from each of the plurality of users to the warranty provider;
a step of notifying the supplier of an occurrence of a second payment from the warranty provider to the supplier in a case where the supplier supplies the warranty part to the warranty provider; and
a step of notifying the supplier issuance of an invoice from the warranty provider to the supplier in a case where replacement of the warranty part of the product belonging to any one of the plurality of users has occurred, the invoice relating to a cost of the warranty part as a replacement target,
wherein the supplier computer is provided with a storage unit configured to store an amount of a pooled fund to be appropriated for a payment of a billing amount of the invoice; and
wherein the method further comprises:
a step of adding an amount of money corresponding to the first payment to the amount of the pooled fund by the warranty supplier when the occurrence of the first payment is notified,
a step of adding an amount of money corresponding to the second payment to the amount of the pooled fund when the occurrence of the second payment is notified, and
a step of subtracting the billing amount of the invoice from the amount of the pooled fund by the supplier computer when the issuance of the invoice is notified.
